(19) United States
(12) Patent Application Publication
(10) Pub. No.: US 2014/0375807 A1
(43) Pub. Date: Dec. 25, 2014

(54) CAMERA ACTIVITY SYSTEM

(71) Applicant: ZF Friedrichshafen AG, Friedrichshafen (DE)

(72) Inventors: Ronald Muetzel, Hawthorn Woods, IL (US); Thomas Roesch, Friedrichshafen (DE)

(21) Appl. No.: 13/926,285

(22) Filed: Jun. 25, 2013

(51) Int. Cl. B60R 1/00; H04N 5/225; H04N 7/18

(52) U.S. Cl. CPC B60R 1/00; H04N 7/18; H04N 5/2251
USPC 348/148

(57) ABSTRACT

A vehicle may be equipped with one or more cameras, each of which may be connected to a storage medium. In turn, the storage medium may be connected to a transmitter that may be used to transmit images (still or video) to a remote server. Image capture may be triggered by various occurrences, events, or signals. An input device, including but not limited to, a button, switch, or voice-activated interface, may be used to trigger image capture.

### BACKGROUND OF THE INVENTION

1. Field of the Invention

The invention relates to a vehicle camera system for capturing activity.

2. Related Art

Digital cameras are increasingly common, whether included in cellular phones, embedded on the exterior or interior of a vehicle, or used as a standalone device. Digital cameras are used by consumers in a multitude of settings to capture events, places, and people. Digital cameras may also be used in safety and security applications. For example, digital cameras may provide the operator of a vehicle with a view of the area directly behind a vehicle. In this way, the operator may avoid reversing the vehicle into an object or person.

Vehicle operators may be tempted to use a digital camera while operating a vehicle, for example, to photograph an interesting site or scene from the road. This presents a dangerous situation in which the operator is not paying attention to driving. In some jurisdictions, using cellular phones, including a camera feature, is prohibited while driving. A system is needed to increase the safety and effectiveness of camera use in a vehicle.

### SUMMARY OF THE INVENTION

The descriptions below include systems and methods for camera activity and use in a vehicle.

A vehicle camera system may comprise a camera; a storage medium in communication with the camera; an input mounted in a passenger compartment of the vehicle; a sensor in the vehicle; a locator in the vehicle; a controller configured to trigger storage of an image generated by the camera in the storage medium based on signals received from the input, sensor, or locator; and a transceiver in communication with the storage medium, the transceiver configured to transmit images captured by the camera.

A vehicle camera system may comprise a plurality of cameras; a storage medium in communication with the plurality of cameras; a plurality of inputs mounted in a passenger compartment of the vehicle, each input of the plurality of inputs uniquely associated with one camera of the plurality of cameras; a sensor in the vehicle; a locator in the vehicle; a controller configured to trigger storage of an image generated by the camera in the storage medium based on signals received from one input of the plurality of inputs, the sensor, or the locator; and a transceiver in communication with the storage medium, the transceiver configured to transmit images captured by the cameras to a server, wherein the images are displayed on a website that is enabled to access the server.

A method for generating images from a vehicle may comprise generating an image; receiving a trigger signal; storing the image upon receiving the trigger signal; tagging the image with a date and time of the image's generation and a location of the vehicle; and transmitting images captured by the camera, generating the trigger signal based on one of the following: generating the trigger signal when an input mounted in a passenger compartment of the vehicle is activated; generating the trigger signal when an accident is detected; and generating the trigger signal from a controller in communication with a GPS receiver.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The embodiments described below may be more fully understood by reading the following description in conjunction with the drawings, in which

FIG. 1 is a diagram of a camera activity system;

FIG. 2 is a diagram of a camera activity system; and

FIG. 3 is a flow diagram of a method for generating images from a vehicle.

### DETAILED DESCRIPTION

The described embodiments may be used to capture an image from a vehicle safely and effectively. A vehicle may be equipped with one or more cameras, each of which may be connected to a storage medium. In turn, the storage medium may be connected to a transmitter that may be used to transmit images (still or video) to a remote server. Access to the remote server may be provided by a website so that users of the camera system may retrieve their images remotely, i.e., from some place other than the vehicle. Users may also acquire the images directly from the storage medium using wired or wireless communication, a portable drive, such as a thumb drive or Universal Serial Bus drive, or other methods of acquiring the image. The image, images, or video captured by a camera may be tagged with the date, time, and location the image, images, or video. Usage of the term “image” herein may refer to still images or video.

Image capture may be triggered by various occurrences, events, or signals. An input device, including but not limited to, a button, switch, or voice-activated interface, may be used to trigger image capture. In one embodiment, the input device is located on the steering wheel of the wheel. This configuration is advantageous because the vehicle operator may trigger the camera system to store an image while safely operating the vehicle. The input device may be located in close proximity to the vehicle operator. In addition to the steering wheel, the input device may be a device located on the inner door panel, armrest, dashboard, or center counsel of the vehicle.

The vehicle may also include a preview display in the interior of the vehicle, for example, in the center counsel of the vehicle. The preview display may show the operator the current view of any number of cameras. Each camera may be continuously capturing images and storing the images in a buffer. The buffered images may then be presented to the operator on the preview display. The buffered images may be shown in a continuous stream or may be sampled at particular rate. For example, the captured image may be shown every five seconds.

The camera or cameras may be mounted on the vehicle. For example, cameras may be embedded in the vehicle bumpers, dashboard, struts, doors, or anywhere on the vehicle body or undercarriage. Standalone cameras or cellular phone cameras may be mounted on the exterior or interior of the vehicle and may be coupled to the storage medium by wired or wireless communications. The camera mounts may be temporary or permanent. An additional input device, or the same input device for storing images, may be used to trigger the storage device or some other intermediate device to upload the image to a remote server. Alternatively, the input device may be voice activated, and may respond to voice commands to trigger image storage, capture, camera zoom or camera pivot.

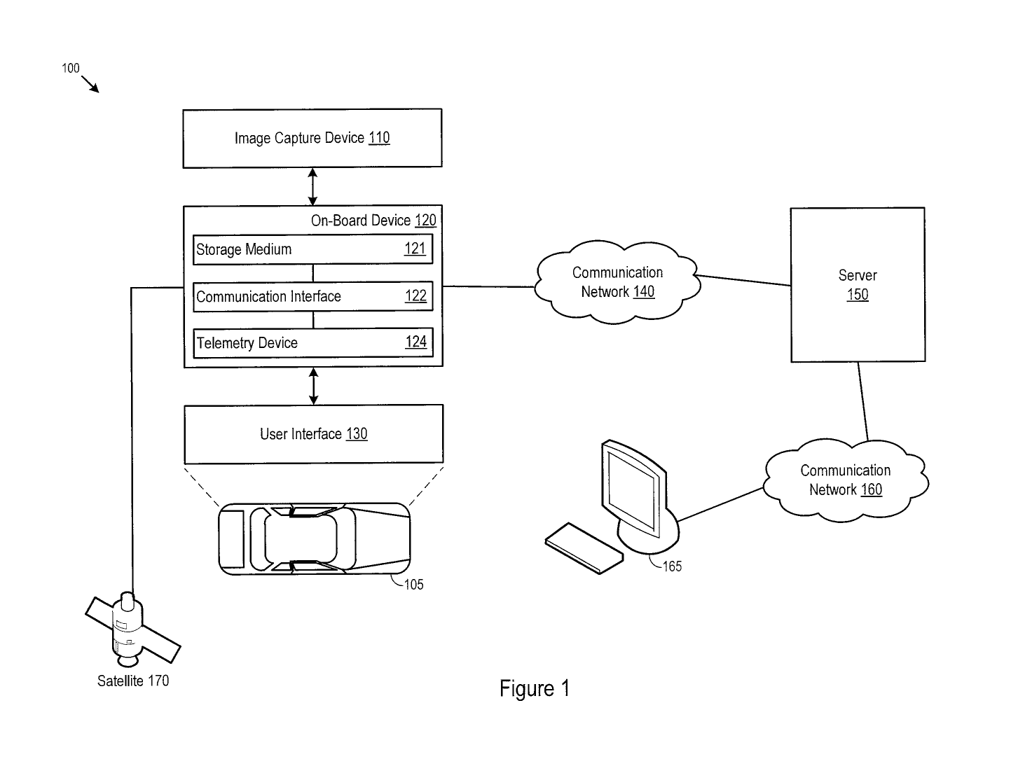

FIG. 1 illustrates a diagram of a camera activity system 100 according to one embodiment of the invention. The camera activity system 100 includes vehicle 105. The exemplary vehicle shown in FIG. 1 is an automobile. However, vehicle 105 may take any number of forms, including as examples, a car, bus, truck, van, mini-van, sports utility vehicle (SUV), construction vehicle, motorcycle, trailer, all-terrain vehicle (ATV), moped, tractor, hybrid vehicle, electric vehicle, ambulance, fire truck, helicopter, airplane, marine vessel, boat, submarine, or other vehicle.

Vehicle 105 may include an image capture device 110, on-board device 120, and user interface 130, any combination of which may be integrated, e.g., installed, within or on vehicle 105. Alternatively, image capture device 110, on-board device 120, and user interface 130, may each be temporarily mounted or installed in vehicle 105. Image capture device 110 may be any device operable to capture a digital image or a series of digital images, such as a camera of any form or type.

On-board device 120 may be communicatively linked to image capture device 110 and user interface 130. On-board device 120 may include storage medium 121 that may be communicatively linked to image capture device 110, and may be used to store images generated by image capture device 110. Storage medium 121 may be any type of memory, disk, or other electronic storage medium, whether volatile or non-volatile. Storage medium 121 may be large enough to hold a significant number of images or minutes of digital video. For example, storage medium 121 may be one terabyte in size. Storage medium 121 may save images generated by image capture device 110.

On-board device 120 may include communication interface 122 communicatively linked with telemetry device 124 and storage medium 121. On-board device 120 may communicate with any number of communication networks through communication interface 122, including communication networks 140 and 160, which may take any number of forms such as a wired or wireless network. On-board device 120 may communicate according to any number of communication protocols, standards, networks, or topologies. As examples, on-board device 120 may communicate across cellular networks or standards (e.g., 2G, 3G, Universal Mobile Telecommunications System (UMTS), GSM® Association, Long Term Evolution (LIE)™, or more), WiMAX, Bluetooth, WiFi (including 802.11 a/b/g/n/ac or others), WiGig, Global Positioning System (GPS) networks, and others available at the time of the filing of this application or that may be developed in the future. On-board device 120 may include processing circuitry, data ports, transmitters, receivers, transceivers, or any combination thereof to communicate across any of the above-listed protocols, standards, networks, or topologies.

On-board device 120 may be configured according to any number of user requirements with respect to communication capabilities, data transfer configurations, data collection configurations, and other configurations. On-board device 120 may also collect any type of vehicle data, such as performance statistics, route information, position data, traffic data, and others. In that regard, on-board device 120 may collect vehicle data with respect to the vehicle 105, different vehicles, groups of vehicles, or any combination thereof. In one example, on-board device 120 may include telemetry functionality or logic, such as telemetry device 124, to collect and/or send vehicle data. Telemetry device 124 may function to capture measurements or records of speed, direction, acceleration, pitch, yawl, and roll, and measurements or records of rate of change for speed, direction, acceleration, pitch, yawl, and roll. One example of on-board device 120 is the Openmatics© on-board unit provided by ZF Friedrichshafen AG.

On-board device 120 may communicate with server 150 through one or more communication networks, such as communication network 140 shown in FIG. 1. Server 150 may be any type of computer server, mainframe, network server, or distributed server or storage space, such as a cloud server.

Server 150 may communicate with other computers, servers, and electronic devices via communication network 160. For example, communication network 160 may be the Internet or part of the Internet. Communication network 160 may be different than communication network 140. Alternatively, communication network 160 may be the same as communication network 140. Personal computer 165 may access content stored on server 150 via communication network 160. The content may be displayed in any form, such as on a website, in a document, in a video stream, in an email, Tweet, or other message in electronic format.

A user of camera activity system 100 may use user interface 130 to trigger the storage of an image in storage medium 121. The image may be generated by image capture device 110. User interface 130 may include a preview display of the image generated by image capture device 110. User interface 130 may be comprised of buttons, switches, knobs, displays, touch screens, or any other type of user interface or control mechanism. Images stored upon triggering may be automatically uploaded via communication interface 122 and communication network 140 to server 150. Images may also be automatically sent to an email address or an internet protocol address. Alternatively, a user of camera activity system 100 may retrieve images directly from storage medium 121 using communication interface 122 or other interfaces of on-board device 120.

The images stored in storage medium 121 may be tagged with the date, time, and location that the image was generated. The date and time may be determined based on a clock internal to on-board device 120. The date, time, and location may be provided by the Global Positioning System (“GPS”). On-board device 120 may receive a GPS signal from GPS satellite 170. Alternatively, the date, time, and/or location may be provided by a cellular phone or a telemetry device.

User interface 130 may also include audio recording capabilities that may record audio associated with an image, a set of images, or digital video. A user may trigger the start of audio recording using user interface 130 and record audio that is linked with the images stored on storage medium 121. The audio may be synchronized with digital video, or may be attached to or associated with a still image or a set of still images. A user may advantageously add a personal comment to stored images. In another embodiment, the user may record only audio, and no image is associated with the audio.

A user may trigger to capture or storage of an image using audio commands detected by user interface 130 or by physical or virtual buttons on user interface 130.

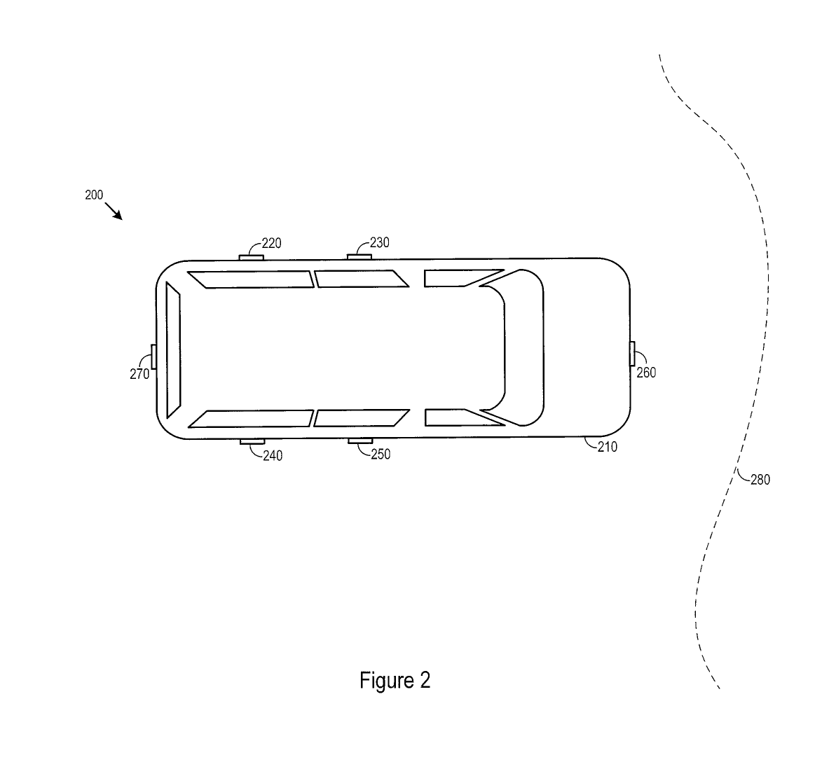

FIG. 2 depicts a diagram of camera activity system 200 according to another embodiment of the invention. Vehicle 210 is depicted as a van, but may be any type of vehicle as described above. Six cameras are installed on vehicle 260, including cameras 220, 230, 240, 250, 260, and 270. Each camera may be communicatively connected to a centralized device, such as on-board device 120 in FIG. 1. Cameras 220, 230, 240, 250, 260, and 270 may be continuously capturing images and storing them in a memory or buffer. These images may be displayed on a screen or screens inside vehicle 210. A trigger mechanism for cameras 220, 230, 240, 250, 260, and 270 may be implemented to trigger storage of images captured by each camera in a storage device located on or remote to vehicle 210. For a storage device that is remote to vehicle 210, the images may be transmitted to a remote storage device over a communications network.

The trigger mechanism for each of cameras 220, 230, 240, 250, 260, and 270 may trigger storage of images (either still images or a set of images comprising digital video) for a number of events or occurrences.

In one embodiment, storage of images may be triggered based on input from a passenger or operator of vehicle 210. For example, vehicle 210 may be a tour bus on which each passenger has a trigger mechanism, e.g., a button, to trigger storage of an image captured by the camera located nearest the passenger's seat. The trigger mechanism may be located on the armrest or windowsill of the vehicle. A passenger may advantageously use the camera while on tour to capture and store images of interesting sites. In another embodiment, camera activity system 200 may be installed on a helicopter or plane. This advantageously provides the passengers the ability to create aerial photographs, for example, while enjoying an aerial tour. In another embodiment, camera activity system 200 may be installed on a boat. This advantageously provides the passengers with the ability to create underwater photographs from the safety of the boat. Later, the stored images may be downloaded by the passenger from an on-board storage device, or may be downloaded from a website that shows the images to the passenger following the tour. The passenger may be free to download images from the website for a specified number of days after the tour. The tour company or other third party may charge a fee for using the camera activity service. Alternatively, loyalty points, e.g., frequent flier miles, may be accepted as payment. Cameras 220, 230, 240, 250, 260, and 270 may have special features that are optimal for use on a tour, such as night vision for touring areas of natural habitat for nocturnal wildlife, wide angle lenses for panoramic photographs, or underwater cameras for photographing sea life.

In one embodiment, storage of images may be triggered based on the detection of an accident or event. Vehicle 210 may include sensors, such as pressure sensors, gyroscopes, temperature sensors, voltage and current monitors, magnetic sensors, microelectromechanical sensors, mechatronic sensors, position sensors, compass sensors, vibration sensors, impact sensors, and noise sensors. The sensors may be communicatively connected to an on-board device that controls a trigger to store images of cameras 220, 230, 240, 250, 260, and 270. Camera activity system 200 may include predetermined thresholds at which a trigger will occur based on input from a sensor. For example, a vehicle may be equipped with a gyroscope that detects the rotational rate of the vehicle. If the gyroscope detects that vehicle 210 is spinning out of control, the storage of the images captured by cameras 220, 230, 240, 250, 260, and 270 will be triggered. The threshold for determining that vehicle 210 is spinning out of control may be 180 degrees per second.

Other sensors may detect events that may be advantageously photographed or recorded by camera activity sensor 210. If vehicle 210 is struck by a moving vehicle, then storage of images captured by cameras 220, 230, 240, 250, 260, and 270 will be triggered. In this way, the images may be used to determine the facts of the accident and the identity of the offending vehicle's operator. This situation may occur while vehicle 210 is in motion or parked. When parked, cameras 220, 230, 240, 250, 260, and 270 may capture a hit-and-run or other criminal activity near vehicle 210. For example, storage of images captured by cameras 220, 230, 240, 250, 260, and 270 may be triggered when noise or vibration sensors on vehicle 210 detect an impact or the sound of a breaking window.

Another trigger mechanism to store images captured by camera 220, 230, 240, 250, 260, and 270 may be signals generated by subsystems in vehicle 210. For example, a braking system in a vehicle, such as an anti-lock brake system, may detect how long and at what pressure the brake pedal is applied. A controller may measure these values and determine whether the duration and pressure of brake pedal application each exceed a predetermined threshold. If a vehicle operator slams on the brakes to avoid an accident, then the brake system or some other system may trigger the capture and/or storage of images from cameras 220, 230, 240, 250, 260, and 270. For example, if the pedal is applied at a pressure greater than or equal to 75 percent of maximum pressure for a duration of 0.5 seconds or more, then images from cameras 220, 230, 240, 250, 260, and 270 may be captured and/or stored.

If images from cameras 220, 230, 240, 250, 260, and 270 are being continuously buffered or continuously stored, then the images may be permanently stored in a storage medium upon receiving a trigger signal. The images captured and buffered prior to the trigger signal may also be stored. For example, if camera activity system 200 has a buffer of 500 images for each camera, and the cameras are capturing images at a rate of 100 images per second, then five seconds of images may be stored capturing events occurring five seconds before the trigger signal occurs. In this way, the events leading up to an accident or other event that triggers image storage may be documented.

Another trigger mechanism may be based on the location of vehicle 210. Location of vehicle 210 may be determined based on GPS coordinates received from a GPS satellite, a telemetry device that tracks movement of vehicle 210, a cellular phone, or other device. Capture and/or storage of images may be triggered when vehicle 210 arrives within a predetermined proximity of a landmark having particular coordinates or a particular address. The trigger may occur when vehicle 210 crosses geofence 280. Geofence 280 may be a virtual boundary defined by a set of latitude and longitude pairs. Geofence 280 may define a geo zone or may trace a political or geographical boundary. A trigger signal may also be emitted by other vehicles or by a building. For example, another vehicle may emit a signal detectable by vehicle 210 when vehicle comes within, for example, 100 feet of the other vehicle. As another example, a building may emit a signal that triggers storage of images captured by cameras 220, 230, 240, 250, 260, and 270 on vehicle 210.

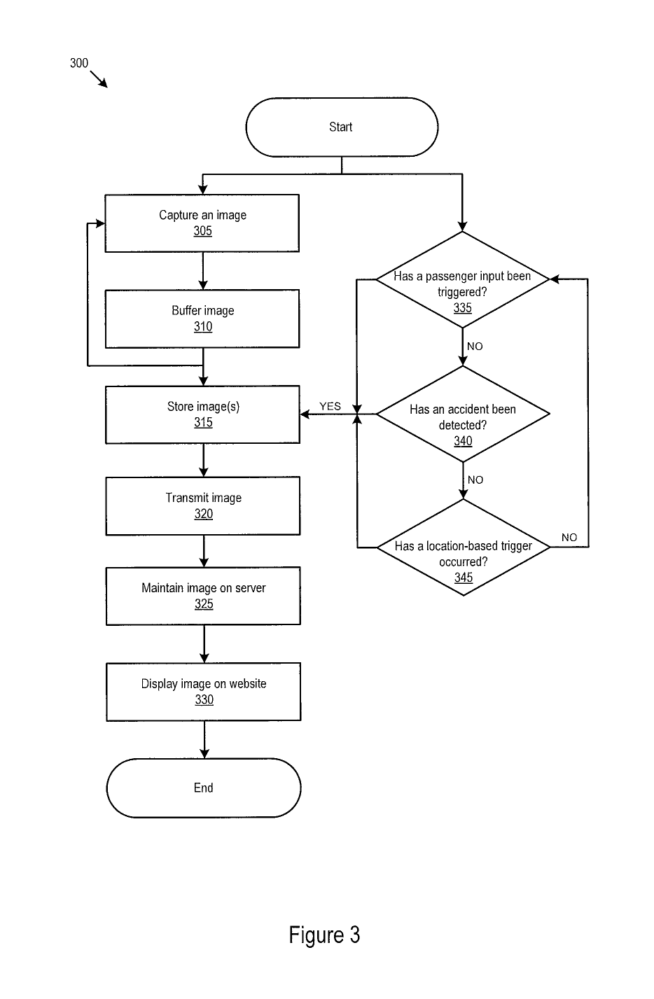

FIG. 3 is a flow diagram of a method for generating images from a vehicle according to one embodiment of the invention. The method 300 may be implemented as hardware, software, or both. For example, vehicle 105 may implement the method 300 through any combination of image capture device 110, on-board device 120, and user interface 130, along with any combination of communication networks 140 and 160, server 150, and personal computer 165.

The method 300 may start and continue to step 305, where image capture device 110 may capture an image. At step 310, the image is buffered. Steps 305 and 310 continue to repeat in a loop. The frequency of the loop may be adjustable or static. The frequency of the loop may also be such that images are buffered at a rate sufficient to generate digital video, such as 15 frames per second or 30 frames per second. Images may be buffered so that multiple consecutive images for a predetermined length of time are buffered. The buffer may be filled over time based on the capture rate and the buffer size.

In parallel to the loop of steps 305 and 310, step 335 is performed. Step 335 inquires as to whether a passenger input has been triggered. This may occur when a passenger in a vehicle triggers the storage of images using a user interface such as user interface 130 in FIG. 1. If a passenger input has not been triggered, method 300 continues to step 340. If a passenger input has been triggered, method 300 continues to step 315.

Step 340 inquires as to whether an accident has been detected. An accident may be detected as described above. For example, sensors located on a vehicle may detect an accident and provide a trigger signal for step 340. If an accident has not been detected, method 300 continues to step 345. If an accident has been detected, method 300 continues to step 315.

Step 345 inquires as to whether a location-based trigger has occurred. A location-based trigger may occur when a vehicle crosses a geofence, arrives within a predetermined proximity of defined GPS coordinates, or comes within a predetermined proximity of another vehicle or a building. If a location-based trigger has not occurred, the method loops to step 335. In this way, method 300 includes a second loop that continues until a trigger event occurs. At step 345, if a location-based trigger has occurred, the method continues to step 315.

Step 315 stores an image, a set of images, or digital video. In step 315, the trigger event from the loop including steps 335, 340, and 345 may cause an image or images buffered in step 310 to be stored in a storage medium. Additional information may be stored with the image, including the time, date, and location that the image was captured and any audio recorded to accompany the image.

In step 320, the stored image is transmitted to a remote server. In step 325, the image is maintained on the remote server. Date, time, and location information associated with the image may be maintained with the image. In addition, any audio or identifying information about a camera user or the image owner may be maintained with the image. In step 330, the image is displayed on a website. The website may include a system for online purchasing or downloading of the image.

Methods or processes may be implemented, for example, using a processor and/or instructions or programs stored in a memory. Specific components of the disclosed embodiments may include additional or different components. A processor may be implemented as a microprocessor, microcontroller, application specific integrated circuit (ASIC), discrete logic, or a combination of other types of circuits or logic. Similarly, memories may be DRAM, SRAM, Flash, or any other type of memory. Parameters, databases, and other data structures may be separately stored and managed, may be incorporated into a single memory or database, or may be logically and physically organized in many different ways. Programs or instruction sets may be parts of a single program, separate programs, or distributed across several memories and processors.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A vehicle camera system comprising:
a camera;
a storage medium in communication with the camera;
an input mounted in a passenger compartment of the vehicle;
a sensor in the vehicle;
a locator in the vehicle;
a controller configured to trigger storage of an image generated by the camera in the storage medium based on signals received from the input, sensor, or locator; and
a transceiver in communication with the storage medium, the transceiver configured to transmit images captured by the camera.

2. The vehicle camera system of claim 1 wherein the trigger is a first trigger, and further comprising a second trigger mounted in the passenger compartment of the vehicle, the trigger in communication with the transceiver, the trigger configured to signal the transceiver to transmit an image generated by the camera.

3. The vehicle camera system of claim 1 further comprising a device configured to tag an image generated by the camera with a date, a time, and a location that the image was generated.

4. The vehicle camera system of claim 3 further comprising a receiver configured to receive the location in GPS coordinates.

5. The vehicle camera system of claim 1 further comprising an audio recorder, the audio recorder configured to record audio and tag an image generated by the camera with the audio.

6. The vehicle camera system of claim 1 wherein the trigger is voice-activated.

7. The vehicle camera system of claim 1 wherein the trigger is activated by a braking system of the vehicle.

8. The vehicle camera system of claim 7 wherein the braking system activates the trigger when the brakes of the vehicle are applied for a predetermined duration and at a predetermined amount.

9. The vehicle camera system of claim 1 wherein the trigger is activated when the vehicle crosses a geofence.

10. The vehicle camera system of claim 1 wherein the storage medium is configured to store an image generated by the camera at a predetermined amount of time before the trigger is activated.

11. The vehicle camera system of claim 10 wherein the storage medium is configured to store an image generated by the camera 60 seconds before the trigger is activated.

12. The vehicle camera system of claim 1 wherein the trigger is activated when the vehicle arrives within a predetermined proximity of particular GPS coordinates.

13. The vehicle camera system of claim 12 wherein the particular GPS coordinates are predetermined or dynamic.

14. The vehicle camera system of claim 12 wherein the camera is configured to generated a series of consecutive images, and the storage medium is configure to store the series of consecutive images as digital video.

15. A vehicle camera system comprising:
a plurality of cameras;
a storage medium in communication with the plurality of cameras;
a plurality of inputs mounted in a passenger compartment of the vehicle, each input of the plurality of inputs uniquely associated with one camera of the plurality of cameras;
a sensor in the vehicle;
a locator in the vehicle;
a controller configured to trigger storage of an image generated by the camera in the storage medium based on signals received from one input of the plurality of inputs, the sensor, or the locator; and
a transceiver in communication with the storage medium, the transceiver configured to transmit images captured by the cameras to a server,
wherein the images are displayed on a website that is enabled to access the server.

16. The vehicle camera system of claim 15 wherein the plurality of triggers are activated by a push-button.

17. The vehicle camera system of claim 15 further comprising an indicator that is activated when the vehicle arrives within a predetermined proximity of GPS coordinates.

18. A method for generating images from a vehicle comprising:
generating an image;
receiving a trigger signal;
storing the image upon receiving the trigger signal;
tagging the image with a date and time of the image's generation and a location of the vehicle; and
transmitting images captured by the camera, generating the trigger signal based on one of the following:
generating the trigger signal when an input mounted in a passenger compartment of the vehicle is activated;
generating the trigger signal when an accident is detected; and
generating the trigger signal from a controller in communication with a GPS receiver.

19. The method of claim 18 wherein the step of generating the image comprises generating the image at a predetermined amount of time before the step of receiving the trigger signal.

20. The method of license plate recognition of claim 18, wherein the step of generating an image further comprises generating a series of images that comprises digital video.
